(19) United States
(12) Patent Application Publication
(10) Pub. No.: US 2006/0212789 A1
(43) Pub. Date: Sep. 21, 2006

(54) Method to improve reading and skimming speed

(75) Inventors: Louis Michael Crowe, Galway (IE); Michael Anthony Fitzgerald, Galway (IE)

Correspondence Address: Cucoco Ltd;Unit 4, Campus Innovation Centre, NUIG, Galway, IE

(73) Assignee: Cucoco Ltd, Galway (IE)

(21) Appl. No.: 11/298,212

(22) Filed: Dec. 12, 2005

(30) Foreign Application Priority Data
Jan. 13, 2005 (IE) S2005/0009

(51) Int. Cl. G06F 17/00

(52) U.S. Cl. 715/500

(57) ABSTRACT

A method and a technology has been developed to improve reading and skimming speed. Not all words are necessary for understanding so these words may be substituted or removed from the text to facilitate reading the text at a higher speed. A set of rules determines which words can be substituted/removed and what proportion of a document can be substituted/removed.

### CROSS REFERENCING TO RELATED APPLICATION

Priority date was established on 13 of January, 2005 with the filing of a Short-Term Irish Patent application, title Method to improve reading, reference number S/2005/0009 which is hereby incorporated by reference herein.

### FIELD OF INVENTION

This invention related to the presentation of text for reading—printed texts, digital texts and audio texts (texts read out).

### BACKGROUND OF INVENTION

Many people would like to be able to read documents more rapidly. However, as their speed increases their comprehension decreases. Furthermore many people have an inability or reluctance to skim documents—in case they may miss something important. The invention helps address both of these issues. Furthermore, as words are substituted the length of the document decreases so it can be printed on less paper or displayed using a larger font.

There are other methods available that allow for the quicker reading of documents. For instance, there are ‘automatic summarizers’. These programs take a given document and present a condensed version of same to the user. However, prior to this invention there was not a systematic way of removing words from a document enabling the reader to go through the whole document but at a faster pace, with the assurance that he/she has gone through the whole of the document.

The Rapid Serial Visualization Process is a system that presents text to a reader one word or several at a time. It does not shorten the document in any way or modify the text. The invention may profitably be used in conjunction with this Process but this process does not anticipate the invention as it does not deal with the removal/substitution of words.

### SUMMARY

A method and a technology has been developed to improve reading and skimming speed. Not all words are necessary for understanding so these words may be substituted or removed from the text to facilitate reading the text at a higher speed. A set of rules determines which words/phrases can be substituted/removed.

### DETAILED DESCRIPTION

A technology has been developed to facilitate rapid reading of a text.

Many words in English are redundant; they are not necessary for comprehension. (The previous sentence could be understood if it was written as: “Many words . . . English . . . redundant; . . . not necessary . . . comprehension”). The definite and indefinite articles are unnecessary except for emphasis; Spanish does hot generally use personal pronouns; many of the Far Eastern languages do not have many of the link words that are in English.

Surprisingly it has been found that you can eliminate up to 40% of words from a typical text and still understand it well. What is crucial is the choice of words to be eliminated.

“I do love you” and “I do not love you” obviously have very different meanings. So ‘not’ is deemed a word critical to understanding and should not be eliminated. By contrast ‘do’ is comparatively unimportant—“I love you” and “I do love you” will be broadly understood to have a similar meaning.

(There are, of course, exceptions where ‘not’ may be eliminated without compromising meaning too much. For instance, ‘not’ as part of a double negative may sometimes be eliminated together with the other negative. However, these are exceptions and are thus dealt with separately by the algorithm).

The words to be eliminated may be manually drawn up to form a list. For instance, the words “The”, “Of”, “a” . . . may form a list. Together they generally account for about 10% of words in a document. These words are chosen for their high redundancy and high frequency of use. The high frequency of use allows the reader to easily accommodate/habituate to the lack of a given word in a document. The high redundancy rate means that the sentence should have a similar meaning with or without the word. By contrast ‘and’ has a higher frequency rating than ‘a’ but a somewhat lower redundancy rating and so ‘a’ would be eliminated in preference to ‘and’. (‘and’ is used to link ideas, etc.).

The redundancy level of a word may be absolute or it may be contextual, e.g. within a certain context or group of words it is never eliminated.

As a general rule it has been found that nouns and verbs are the most important words and in general should be the last to be eliminated. Adverbs, adjectives, auxiliary verbs, personal pronouns and link words/conjunctions are generally found to be of diminishing semantic importance. The algorithms may reflect this or another hierarchy. For instance, in one embodiment all words except nouns and verbs are eliminated except proper nouns, capitalised words, words in italics, bold and any word from a list that is thought to radically change the meaning of the surrounding sentence, e.g. not, without, never, etc.

A weighted matrix to assist the elimination process may be applied using assigned frequency and redundancy scores.

The rate of deletion may be pre-selected or chosen by the user. This rate may be absolute, i.e. words are progressively eliminated until the desired level of elimination is achieved, or approximate where a standard list is used which typically would eliminate the desired %. Words may also be chosen from a list by the user determining whether the words are eliminated or not.

Below are lists of words which together make up a large proportion of words which are suitable for removal/substitution. In the digital versions the user may be allowed define what percentage of words he/she would like to be removed/substituted, or he may customize the list.

The, a, of between them typically constitute about 10% of a document and can be eliminated with little loss of understanding.

The, a, of, to, in, is, you, it, he, was, for typically constitute about 20% of a document

The, a, of, to, in, is, you, it, he, was, for, on, are, as, his, they, I, at, be, have, had, by, what, all were, we, your, can, said typically constitute about 30% of a document

The, a, of, to, in, is, you, it, he, was, for, on, are, as, with, his, they, I, at, be, this, have, from, had, by, what, all, were, we, when, your, can, said, an, each, which, she, do, how, their, will, up, other, about, out, many, then, them, these, so, her, would, him, into, has, more, see, number, way, could, people, water, been, call, who, its, now, long, down, day, did, may typically constitute about 40-50% of a document

(A list may include common variations on a word, e.g. ‘numbers’ in addition to ‘number’).

High deletion rates facilitate very rapid document skimming. (The objective here is not total comprehension but rather to understand the gist of what is being said). When used in conjunction with the Rapid Serial Visualisation Technique, described below, even greater reading efficiencies may be achieved.

It should be noted that the techniques described herein are not limited to the English language. They can be modified and applied to most languages and that the scope of the invention is not limited to the examples given. Furthermore, they may be applied to audio technologies as well—where the listener only hears the most important words, the other words being compressed or eliminated.

The deleted word may be simply eliminated. In one preferred embodiment it is eliminated together with an accompanying full space. In another preferred embodiment the eliminated word(s) (with or without the space) may be substituted with a symbol. For instance a small dot. In this particular example its position may be raised/lowered from the writing line. It has been surprisingly found that the inclusion of a small, condensed symbol for the substituted word(s) facilitates comprehension.

The use of this technology also allows the reader to increase his reading speed by increasing the effective amount of text read in a single fixation (individual focus/glance). E.g. If a user can typically take in 20 characters in a fixation these 20 characters might stretch over say 5 words instead of his normal 3 words, (because 2 words had been deleted).

As an alternative to word elimination it has been surprisingly found that there is an advantage to be gained by ‘visually demoting’ the less important words. By way of example, ‘the’ may be visually demoted by one or a combination of font size and/or colour and/or bold-unbold and or italics, etc.. This allows the reader to ‘hop’ from important word to important word with the reassurance of having the ‘demoted’ words available to him if he needs them for comprehension.

Phrase substituter. There are long ways of saying things; there are concise and grammatically correct ways and there are concise and non-grammatically correct ways. If the objective is to convey the approximate meaning in a way that can be communicated more rapidly new avenues of elimination and substitution are possible. For instance, “and after that” can be substituted with “then” with little loss of meaning. For “in addition to that” a “plus” may be substituted, or simply “+”

It has been found that the most important parts of a document tend to be the first and last paragraphs, or those listed under headings such as ‘introduction’, ‘conclusion’, etc. It has also been found that the most important part of a paragraph tends to be the first and last sentences. The ‘compression’ of the document can be made to reflect this varying importance of sentences/paragraphs. For instance, fewer words would be extracted in the first and last line of a paragraph than in the body of the paragraph. Furthermore, in a preferred embodiment headings, bolded italicize (or otherwise emphasized) words are not removed/substituted, or substituted at a lower rate.

The Rapid Serial Visualization Technique is well known to those knowledgeable in the art of training people to read quickly. Words or groups of words are presented to the reader in rapid succession on a screen. The word removal/substitution technique has particular advantages when used in conjunction with this technology. By way of example, if one word is being displayed at a time, (the words in the text are presented sequentially), the removed word is simply not displayed at all, with the next non-removed word from the text being displayed. Alternatively the substitute for the word may be displayed for the normal time of display or a fraction of it. Alternatively the word itself could be displayed for a proportion of the normal display period. It is evident that there are a large number of variations on this theme, especially when more than one word is being displayed at a time.

In a preferred embodiment of the invention the words/phrases to be are removed/substituted in an easily reversible process. By way of example a computer user has the default OFF—that is the text is not treated by any removals or substitutions unless he chooses to activate it, e.g. he presses a button. He may revert to the original text easily by a similar easily performed action. Depending on the set up of the software the document reverts to the un-removed/un-substituted state if he prints, saves, emails or copies the text.

1. A computer-based method to allow greater reading speed with limited interference in the readers' comprehension of the text by substituting or removing words in the document that will have least effect on the readers' understanding of the text.

2. A method of presenting the text of a document more rapidly using the Rapid Serial Visualization Process whereby some words are not presented at all or for a shorter time period than other words

3. A method, as in either claim 1 or 2, where the removal or substitution of words is easily reversible, e.g. in a digital format at the pressing of a button.
